(19) United States
(12) Patent Application Publication
(10) Pub. No.: US 2010/0078539 A1
(43) Pub. Date: Apr. 1, 2010

(54) BEVERAGE CUPHOLDER HOUSING FOR A VEHICLE

(76) Inventor: Dana A. Erickson, Richfield, MN (US)

Correspondence Address: NAWROCKI, ROONEY & SIVERTSON;SUITE 401, BROADWAY PLACE EAST, 3433 BROADWAY STREET NORTHEAST, MINNEAPOLIS, MN, 554133009, US

(21) Appl. No.: 12/527,814

(22) PCT Filed: Feb. 19, 2008
(86) PCT No.: PCT/US08/54262

§ 371 Date: Aug. 19, 2009

Related U.S. Application Data
(60) Provisional application No. 60/891,399, filed on Feb. 23, 2007.

(51) Int. Cl. B60N 3/10

(52) U.S. Cl. 248/311.2

(57) ABSTRACT

A cupholder unit support structure retrofits into certain predetermined auto models such as BMW 3, 5 and 7 series having an original equipment armrest holding a cupholder of limited value. The armrest and the OEM cupholder is mounted between side by side bucket seats on a bracket attaching the original armrest and cupholder to the transmission tunnel. The invention comprises a housing for supporting an improved cupholder in the form of a cassette or self-contained unit. The housing fits between the armrest proper and the bracket and supports the armrest above and spaced from the bracket. The housing has features that match the mounting configurations of the armrest as it attaches to the bracket and the bracket as it attaches to the armrest. This allows the armrest to be securely mounted on the housing with the cupholder conveniently available just below the armrest. In a preferred embodiment, the housing has flanges on the top and bottom thereof. Mounting plates clamp the housing to both the armrest and the bracket.

### BACKGROUND OF THE INVENTION

The cupholders provided in certain vehicles do not securely hold cups or beverage cans. When a cup or beverage can falls or tips from a cupholder for any reason, the contents usually spill, at best creating a mess. As one imagines, this is enormously inconvenient. In fact, the distraction such an event causes can even affect safe operation of the vehicle.

A customary design for cupholders has a cup aperture in a plate or support ring for receiving the cup or can. The center aperture size and design provides lateral support for common sizes of cups and beverage cans. A cupholder ideally has a bottom stop or floor that supports the cup or can with the top projecting from the aperture plate perhaps 5-10 cm.

Some auto models have cupholders molded into a horizontal surface of either the armrest or the space between the armrest and the shift lever. In particular, a number of previous BMW sedan models still common on American and European roads have a shallow cupholder in a horizontal surface above the transmission tunnel between the driver and passenger seats. The cupholder location is between the dash and the shift lever. The shift lever is immediately behind the lower, center area of the dashboard. An armrest is located behind the surface carrying the cupholder. The BMW armrest can slide on a track between a forward position near to the cupholder surface and an aft position between the driver's and passenger's seats.

This cupholder design is particularly problematic. The shallow cupholder between the dash and the shift lever makes it all too easy for the driver to inadvertently push a cup or can forward, where it spills its liquid contents onto the radio and HVAC controls and into the shifter mechanism of the vehicle. The liquid will often cause the controls to operate improperly. Correcting the effects of such a spill is costly, running as much as hundreds of dollars for each spill. This problem has not been lost on owners of these vehicles.

Other makes and models of vehicles have a design that allows the user to deploy the cupholder from a housing or case mounted on an approximately vertical surface of the dash or armrest. Such retractable cupholders have a release mechanism that includes a user-operated latch. The latch releases a spring that that slides the cupholder along a support track forming a part of the housing to deploy the cupholder for use. After use, the user pushes the cupholder back into the housing against the force of the spring. The latch retains the cupholder within the housing against the force of the spring until another release mechanism operation.

Indeed, newer models of BMW autos have quite an excellent spring-loaded cupholder unit integrated in the upper face of the dash. This cup holder unit has a cassette type of construction with a case into which the user retracts the cupholder from an extended or deployed position. The case also holds the operating elements (spring, track, latch, etc.) for storing and deploying the cupholder structure itself.

This design has a mounting flange integral with the case. Mounting screws attach the cupholder unit in a suitably shaped and sized opening in the armrest. The flange has an aperture through which the cupholder projects under spring force when a release button on the cupholder is pressed. When the cupholder usage is over, the user pushes the cupholder against the force of the spring into the case to await the next use.

So, some older BMW auto models place an unfortunately located and relatively unreliable cupholder at the user's disposal. An improved cupholder will be welcome for owners of such cars.

FIG. 1 shows the elements of a standard older BMW 3, 5 and 7 series armrest relevant to the invention. The armrest has a bottom attachment plate 97 forming the floor of a storage compartment within the armrest. Attachment plate 97 in the original configuration of such an auto as shipped by the factory is mounted on an armrest bracket 100. Armrest bracket 100 in the design shown has two legs 102 and 111 that extend in parallel fashion.

Armrest bracket 100 is attached between the driver and front passenger seats, to an upwardly facing surface of the transmission housing by fasteners not shown that pass through holes 114, and by slots that receive the free ends of legs 102 and 111. Threaded fasteners 57 pass through holes 105 and into holes 99 to attach bracket 100 to attachment plate 97 after ends of legs 102 and 111 have been slipped into their respective slots. The threaded fasteners 57 attach bracket 100 to attachment plate 97 before bracket 100 is attached to the transmission housing.

For convenience of description, the spacing and size of holes 99 in attachment plate 97 form at least a part of an “armrest attachment configuration.” As found on the BMW 3, 5 and 7 series, this armrest attachment configuration comprises the four spaced holes 99 forming the corners of a rectangle into which the threaded fasteners 57 screw. Of course, many other types of armrest attachment configurations may exist.

For convenience of description, the spacing and size of holes 105 comprise at least a part of a “bracket attachment configuration.” As found on the BMW 3, 5 and 7 series, this bracket attachment configuration comprises the four spaced holes 105 forming the corners of a rectangle through which the threaded fasteners 57 to attach bracket 100 to attachment plate 97. Of course, many other types of bracket attachment configurations may exist.

Whatever may comprise a bracket attachment configuration, it must be compatible with the armrest attachment configuration, i.e. allow the attachment plate 97 to fasten to bracket 100. The term “compatible” here means that one component can be firmly attached to another using the attachment configurations of the two components and screws, clips, or other fastening devices.

### BRIEF DESCRIPTION OF THE INVENTION

The current invention is an after-market cupholder support structure intended to replace poorly designed original equipment retractable cupholders. The embodiment shown is an assembly intended to replace an original equipment cupholder incorporated in an automobile's armrest by the manufacturer.

Such a cupholder unit support structure is for retrofitting into a predetermined auto model having an original equipment armrest including an armrest attachment plate on the bottom thereof and having an armrest attachment configuration. The armrest attachment plate originally attached with fasteners to an original equipment armrest bracket detachably mounted on an upwardly facing surface within the interior of the. The bracket has a bracket attachment configuration compatible with the armrest attachment configuration

The support structure forming the invention comprises a unitary housing having left and right side elements and a front wall. The front wall has an aperture configured to receive and support a cupholder unit. The left and right side elements have an upper surface with an attachment configuration compatible with the armrest attachment configuration, and a lower surface compatible with the bracket attachment configuration.

In a particular armrest assembly embodiment as supplied from the factory, the armrest attachment configuration includes a portion of the armrest attachment plate having a plurality of mounting holes, and fasteners that enter said mounting holes. For such an armrest attachment configuration, a side element's upper surface includes an upper flange extending along at least one side element and toward the other side element, and further includes at least a first mounting plate having at least two holes therein to be aligned with two mounting holes.

For installation, each mounting plate hole accepts a fastener. The housing attaches to the armrest attachment plate by attaching the first mounting plate to the armrest attachment plate with fasteners in the mounting holes, with the upper flange clamped between the mounting plate and the armrest attachment plate.

For this particular armrest assembly embodiment, the bracket attachment configuration comprises a plurality of bracket mounting holes through which threaded fasteners may pass and screw into the armrest's mounting holes.

A side element of the housing includes a lower flange extending along at least a portion of the flange's respective housing side and toward the other side element. A second mounting plate has at least two holes therein to be aligned with two bracket mounting holes. Each second mounting plate hole accepts a threaded fastener. The housing attaches to the armrest bracket by attaching the second mounting plate with threaded fasteners to the armrest bracket, with the left and right sides' lower flanges clamped between the second mounting plate and the armrest bracket.

This structure allows mounting of a cupholder in the form of an improved, self-contained unit in the armrest assembly of certain types of autos.

### BRIEF DESCRIPTION OF THE DRAWINGS

FIG. 1 shows relevant portions of the armrest and the armrest bracket with which the cupholder support structure interfaces.

FIG. 2 is an exploded perspective view of a structure for supporting a cupholder unit in the form of a cassette to be mounted in a opening of an upright plate of the structure.

FIG. 3 is a section view of the support structure shown in FIG. 2.

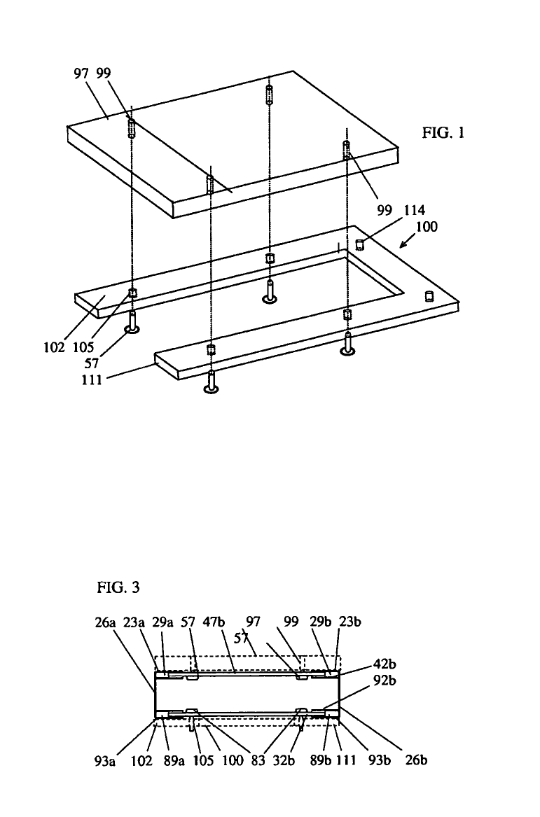

### DESCRIPTION OF THE PREFERRED EMBODIMENTS

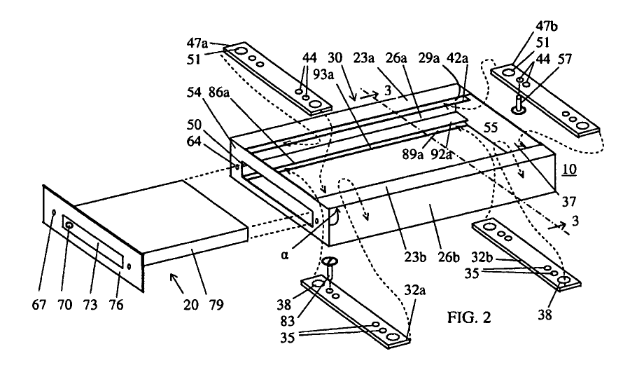

The exploded perspective view in FIG. 2 shows a cupholder unit support structure 10. Support structure 10 includes a housing 30 with an opening 50 designed to receive a cupholder unit 20, for example one as shown in the form of a cassette.

Support 10 is designed to install between an original armrest attachment plate 97 and an armrest support bracket 100 such as found in the BMW 3, 5 and 7 series auto designs widely sold between approximately five and 15 years or so ago. With support 10 installed, the armrest position is elevated by the thickness (height) of support structure 10. This added elevation of the armrest does not appear to be uncomfortable or inconvenient for the driver.

Cupholder unit 20 shown in FIG. 2 is a standard part available from sources such as BMW dealerships. Cupholder unit 20 includes a housing or case 79 with a flat escutcheon-like faceplate 76. Faceplate 76 has a central opening through which a cupholder element 73 projects when deployed.

FIG. 2 shows the cupholder element 73 in the retracted position, with the end thereof approximately flush with faceplate 76. A release button 70 on the end of element 73 operates an internal latch that allows the internal spring to propel cupholder element 73 into its deployed or extended position. As is well known, cupholder element 73 has a circular aperture sized to receive and support a cup or can in the upright position. Element 20 may include a cup support on which the cup or can bottom may rest, to prevent the cup or can from wedging in the aperture. The internal details of the cupholder unit 20 are irrelevant to the invention.

The housing 30 shown in FIG. 2 has a front wall 54 with the opening 50 and holes 64 for attaching unit 20. A back wall 55 is joined to front wall 54 by side walls 26a and 26b.

A pair of upper mounting flanges 23a and 23b attach to and extend along an upper edge (as shown in FIGS. 2 and 3) of side walls 26a and 26b respectively. A pair of lower mounting flanges 93a and 93b attach to and extend along lower edge of side walls 26a and 26b respectively. A second set of flanges 42a, 42b, 92a, 92b are spaced close to flanges 23a, 23b, 26a, and 26b respectively to form respective slots 29a, 29b, 89a, and 89b. The purpose of slots 29a, 29b, 89a, and 89b will be explained below.

Since some types of cupholder units 20 have a slanted front faceplate 76 from which cupholder element 73 slides more or less parallel to the walls of case 79, a neater installation results if front wall 54 has a matching angle α with flange 23a. The types of cupholder units 20 currently available fit best on a housing 30 having an angle α that is in the range of 70-80° and most preferably 76-78°.

A pair of first or upper mounting plates or bars 47a and 47b form a part of an attachment configuration that is compatible with the armrest attachment configuration. Plates 47a and 47b have a length and width that allow them to be slipped into slots 29a and 29b in a position to extend transversely from side wall 26a to side wall 26b. The dashed, curved arrows extending from the ends of plates 47a and 47b indicate the positions that plates 47a and 47b will take in slots 29a and 29b during installation of housing 30. FIG. 3 further shows how plates 47a and 47b fit in slots 29a and 29b. Properly spacing plates 47a and 47b from each other along slots 29a and 29b aligns holes 44 with holes 99 to further conform the support structure 10 attachment configuration to the armrest attachment configuration of attachment plate 97.

Bushings 51 mounted at the ends of each plate 47a and 47b preferably comprise a layer of resilient material having a thickness sufficient to create an interfering, frictional fit for plates 47a and 47b within slots 29a and 29b. This fit allows an installer of a housing 30 to insert plates 47a and 47b within slots 29a and 29b to maintain any desired position along slots 29a and 29b and yet allows the installer to shift plates 47a and 47b into an attachment configuration that is compatible with the armrest attachment configuration. Bushings 51 simplify mounting housing 30 on armrest attachment plate 97.

Holes 44 near the ends of plates 47a and 47b have a spacing that allows their placement in alignment with a pair of holes 99 in attachment plate 97. Plates 47a and 47b may have more than one pair of holes 44 as shown, to accommodate attachment plates having two different spacings of holes 99 forming a part of two different armrest attachment configurations. Fasteners 57, typically threaded, can fit through and screw into holes 44 to fasten housing 30 to attachment plate 97.

A similar mechanism fastens housing 30 to bracket 100. Mounting plates or bars 32a and 32b fit in slots 89a and 89b formed by flanges 93a, 92a and 93b, 92b respectively. Fasteners 83, again preferably threaded, fit through holes 35 in plates 32a and 32b and into holes 105, to clamp housing 30 to bracket 100.

Again, the spacings of plates within slots 89a and 89b and the spacing of individual holes in plates 32a and 32b cooperate to form an attachment configuration that is compatible with the bracket attachment configuration. Plates 32a and 32b may also have resilient bushings 38 to retain plates 32a and 32b in a desired position during installation.

Housing 30 including all eight flanges thereon, plates 32a and 32b, and plates 47a and 47b may all comprise aluminum stock that is approximately 0.125″ (3 mm.) thick. In this case, slots 29a, 29b, 89a, and 89b should be slightly wider than 3 mm. to provide therein, a proper interference fit for plates 47a, 47b, 32a, and 32b.

To install housing 30, first housing 30 is attached to bracket 100 as described. Then housing 30 is attached to attachment plate 97 as described. It is convenient to install cupholder unit 20 at this point, using screws passing through holes 67 into holes 64. Then fasteners not shown pass through holes 114 to attach bracket 100 to the upper surface of the transmission housing.

This completes the installation, providing a much improved cupholder for use in autos having the bracket 100 and attachment plate 97 structure.

1. A cupholder unit support structure for retrofitting into a predetermined auto model having an original equipment armrest including an armrest attachment plate on the bottom thereof and having an armrest attachment configuration, said armrest attachment plate originally attached with fasteners to an original equipment armrest bracket detachably mounted on an upwardly facing surface within the interior of the auto model, said bracket having a bracket attachment configuration compatible with the armrest attachment configuration, said support structure comprises a unitary housing having left and right side elements and a front wall, said front wall having an aperture for receiving and supporting a cupholder unit, said left and right side elements having an upper surface with an attachment configuration compatible with the armrest attachment configuration, and a lower surface compatible with the bracket attachment configuration.

2. The support structure of claim 1, wherein the armrest attachment configuration includes a portion of the armrest attachment plate having a plurality of mounting holes, and fasteners that enter said mounting holes, and wherein a side element's upper surface includes an upper flange extending along at least one side element and toward the other side element, and further including at least a first mounting plate having at least two holes therein to be aligned with two mounting holes, and each hole for accepting a fastener, said housing attachable to the armrest attachment plate by attaching the first mounting plate to the armrest attachment plate with fasteners in the mounting holes, with the upper flange between the mounting plate and the armrest attachment plate.

3. The support structure of claim 2, where a side element includes a wall facing and substantially parallel to the upper flange to define therebetween a slot, and said first mounting plate having a dimension to fit within the slot.

4. The support structure of claim 3, wherein each side element includes an upper flange extending toward the other of the side elements, and further including a pair of first mounting plates.

5. The support structure of claim 2, wherein the bracket attachment configuration comprises a plurality of bracket mounting holes through which threaded fasteners may pass and screw into the armrest attachment plate's mounting holes, and wherein a side element includes a lower flange extending along at least a portion of the flange's respective housing side and toward the other side element, and further including at least a second mounting plate having at least two holes therein to be aligned with two bracket mounting holes, and each hole for accepting a threaded fastener, said housing attachable to the armrest attachment plate by attaching the second mounting plate with threaded fasteners to the armrest attachment, with the left and right sides' lower flanges between the second mounting plate and the armrest attachment plate

6. The support structure of claim 5, where a side element includes a wall facing and substantially parallel to the lower flange to define therebetween a slot, and said second mounting plate having a dimension to fit within the slot.

7. The support structure of claim 6, wherein each side element includes a lower flange extending toward the other of the side elements, and further including a pair of second mounting plates.

8. The support structure of claim 7, wherein each side element includes an upper flange extending toward the other of the side elements, and further including a pair of first mounting plates.

9. The support structure of claim 3, wherein the mounting plate includes at an end thereof, a layer of resilient material.

10. The support structure of claim 2, where a side element includes a wall facing and substantially parallel to the upper flange to define therebetween a slot, and said first mounting plate having an end within the slot.
